(19) United States
(12) Patent Application Publication
(10) Pub. No.: US 2008/0279050 A1
(43) Pub. Date: Nov. 13, 2008

(54) Timepiece with alert timer

(76) Inventors: Marina Ling Chen, Los Angeles, CA (US); Christine Ching-Yu Ko, Los Angeles, CA (US)

Correspondence Address: DAVID AND RAYMOND PATENT FIRM, 108 N. YNEZ AVE., SUITE 128, MONTEREY PARK, CA, 91754, US

(21) Appl. No.: 11/801,878

(22) Filed: May 11, 2007

(51) Int. Cl. G04F 10/00

(52) U.S. Cl. 368/109

(57) ABSTRACT

A timepiece includes a time provider providing a current time and an alert timer. The alert timer includes a time setter setting a time interval at the current time as a starting time, a time processor counting the time interval starting from the starting time, and a signal generator automatically and timely generating an alert signal in a punctual time manner when said time processor is finished counting the time interval in responsive to the starting time.

### BACKGROUND OF THE PRESENT INVENTION

1. Field of Invention

The present invention relates to a timepiece, and more particularly to a timepiece with an alert timer, wherein when the user sets a time interval with respect to the current time of the timepiece, the alert timer will automatically and timely generate an alert signal in a punctual time manner.

2. Description of Related Arts

As the development of economy, the work efficiency is considered of importance to us now. People always plan their schedule everyday, which creates needs of some devices automatically giving a suggested signal according to the designed time. Accordingly, the designed time is set by the user in such a manner that the user will be reminded in responsive to the scheduled time.

There are many kinds of timers in the existing market. People generally can carry a timepiece, such as a watch or a clock, such that they can count the time by themselves. Accordingly, such timepiece is a mechanical timepiece or an analogy timepiece. However, such timepiece cannot generate any alert or reminding signal. In other words, it is a hassle for the people to keep checking the time from the timepiece every minute. Of course, people can also carry a clock with built-in alarm device such that they can set up a time to provide a kind of reminding signal. However, such alarm-clock is much bigger than the watch. It is inconveniently for people to carry a clock everywhere. In addition, the user must set the designated time but not the time interval for such electronic mechanical to generate the reminding signal. Thus, people cannot precisely set the time for such mechanical timepiece.

In order to solve the above problem, a kind of electronic or digital timepiece, such as electronic watch or electronic clock, are popular among people for a time in the world. With this kind of electronic timepiece, the user can set an alarm time and take the electronic timepiece along with him anyplace. Despite its advantages and usefulness, there are some problems with the electronic watch. Firstly, the appearance of the electronic watch is not usually good as the mechanical watch, especially not fit for adults. Secondly, the quality is not as good as the mechanical watch. In addition, the user must set the designated time but not the time interval for such electronic timepiece to generate the reminding signal. In other words, when the user wants to set the alarm 45 minutes after the current time, he or she must calculate the designated time by adding 45 minutes to the current time.

Thanks to the development of technology, mobile phones become more and more popular among us. The mobile phone is small in size for pocketing and can automatically give a time alarm according to the designed time set by the user, depending on which, the user can do his next schedule without delay. But there is still a drawback with such mobile phones. The user must still calculate the designated time based on the current time as mentioned above.

As a result, all timepieces, including the mechanical timepiece, electronic timepiece, mobile phone and the like, require a relatively complicated process to set up the alarm. For example, when the user wants to set up the alarm 1 hour and 28 minutes after the current time of 13:58, he or she must calculate the designated time by adding the current time with the time interval of 1 hour and 28 minutes. If the user fails to calculate the designated time correctly, the reminding signal is meaningless for the user.

### SUMMARY OF THE PRESENT INVENTION

A main object of the present invention is to provide a timepiece with an alert timer, wherein when the user sets a time interval with respect to the current time of the timepiece, the alert timer will automatically and timely generate an alert signal in a punctual time manner.

Another object of the present invention is to provide a timepiece with an alert timer, wherein the set up process is simple and easy by setting the time interval to the timepiece such that the timepiece will automatically provide the current time and the alert timer will count the time in responsive to the time interval. In other words, no calculation for the user is needed to set the designated time.

Another object of the present invention is to provide a timepiece with an alert timer, wherein the alert timer is adapted to incorporate with all kinds of timepiece, including mechanical timepiece, electronic timepiece, mobile phone and the like, without alternating the original structural or electronic configuration of the timepiece.

Another object of the present invention is to provide a timepiece with an alert timer, wherein no complicated mechanical and electronic device for the alert timer is involved in installing or incorporating with the timepiece, so as to substantially reduce the cost of the timepiece with the alert timer.

Accordingly, in order to accomplish the above objects, the present invention provides a timepiece, comprising:

a time provider providing a current time; and

an alert timer which comprises a time setter setting a time interval at the current time as a starting time, a time processor counting the time interval starting from the starting time, and a signal generator automatically and timely generating an alert signal in a punctual time manner when said time processor is finished counting the time interval in responsive to the starting time.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the timepiece with alert timer according to a preferred embodiment of the present invention, illustrating the timepiece being embodied as an electronic watch.

FIG. 2 is a block diagram of a timepiece with the alert timer according to the above preferred embodiment of the present invention.

FIG. 3 is a flow diagram illustrating a process of setting the alert of the timepiece with the alert timer according to the above preferred embodiment of the present invention.

FIG. 4 is a perspective view of the timepiece with alert timer according to the above preferred embodiment of the present invention, illustrating the timepiece being embodied as a mechanical watch.

FIG. 5 is a perspective view of the timepiece with alert timer according to the above preferred embodiment of the present invention, illustrating the timepiece being embodied as a mobile phone.

### DETAILED DESCRIPTION OF THE PREFERRED EMBODIMENT

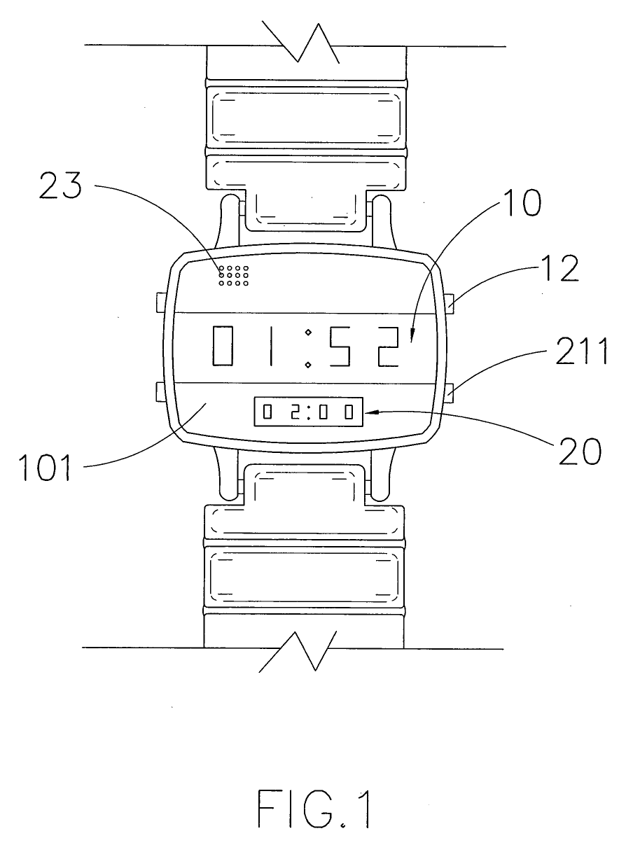

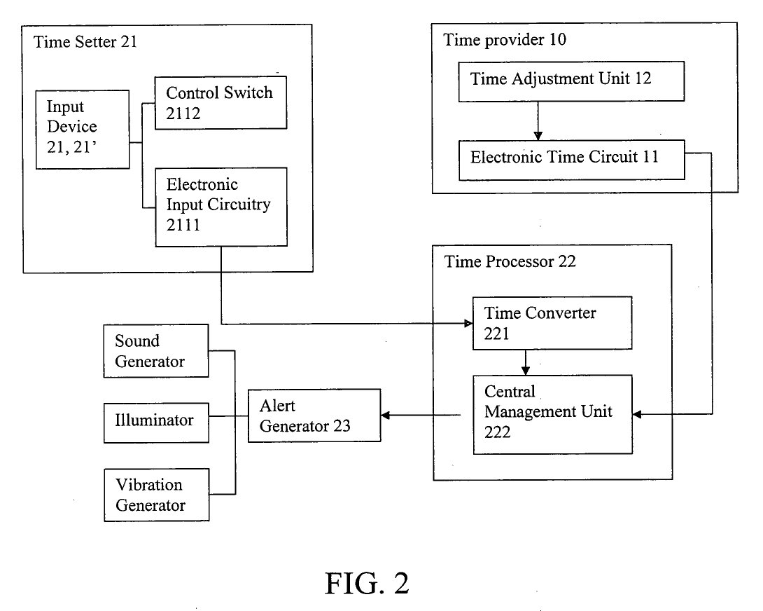

Referring to FIGS. 1 to 2 of the drawings, a timepiece according to a preferred embodiment of the present invention, wherein the timepiece comprises a time provider 10 and an alert timer 20.

The time provider 10, such as an existing watch or clock, is an instrument for measuring time. The time provider 10 provides a current time including hour and minute indications. Accordingly, a second indication is an option for the time provider 10.

The alert timer 20 comprises a time setter 21 setting a time interval at the current time as a starting time, a time processor 22 counting the time interval starting from the starting time, and a signal generator 23 automatically and timely generating an alert signal in a punctual time manner when said time processor 22 is finished counting the time interval in responsive to the starting time.

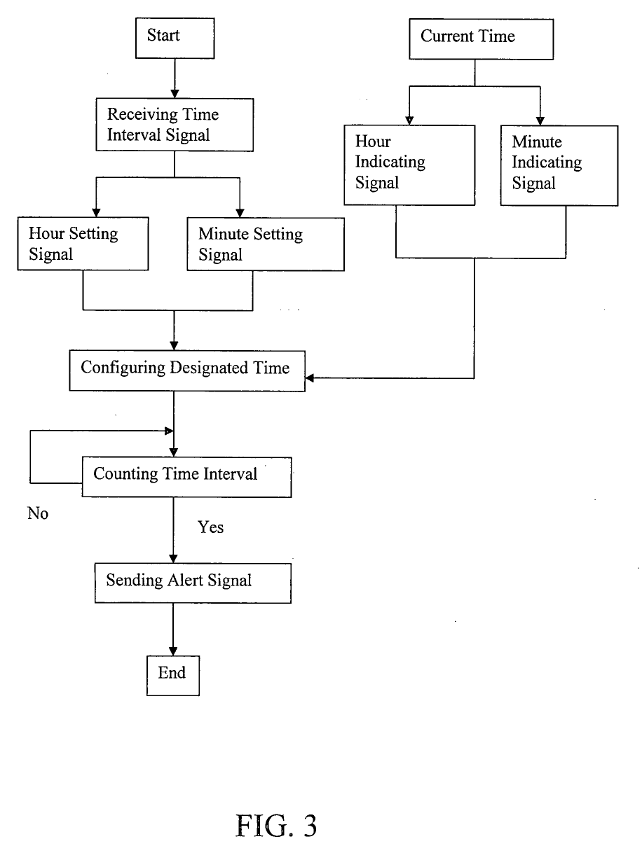

As shown in FIG. 3, the present invention also provides a method of configuring an alert of a timepiece, comprising the following steps.

(1) Provide a current time as a starting time.

(2) Set a time interval at the current time.

(3) Count down the time interval from the starting time.

(4) Automatically and timely generate an alert signal in a punctual time manner once the time interval is over.

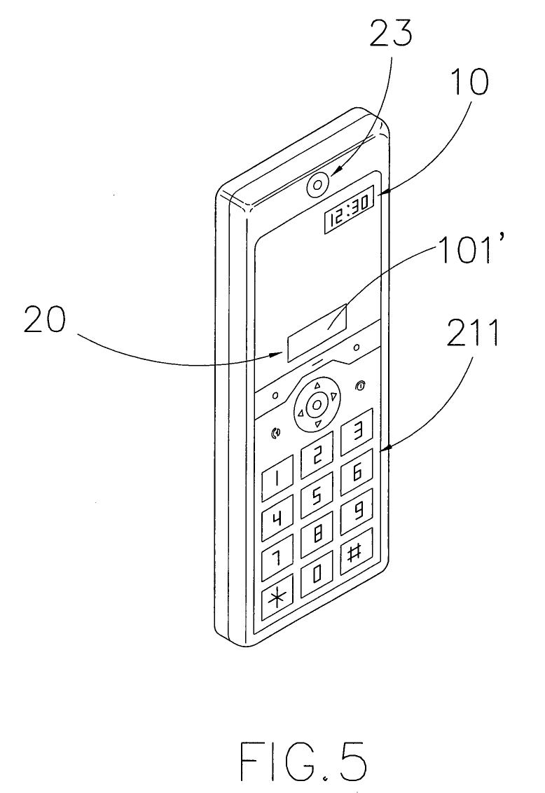

According to the preferred embodiment, the time provider 10, which is embodied as an electronic watch, PDA, or mobile phone as shown in FIG. 5, comprises an electronic time circuit 11 generating a hour indicating signal and a minute indicating signal. Accordingly, the time provider 10 comprises a display screen 101 for displaying the current time in responsive to the hour indicating signal and the minute indicating signal. A second indicating signal is an option to be generated by the electronic time circuit 11 and to be displayed on the display screen. In addition, the time provider 10 further comprises a time adjustment unit 12 operatively linked to the electronic time circuit 11 to selectively adjust the current time. For example, the electronic watch can be manually adjusted the current time via the functional button as the time adjustment unit 12. Likewise, the mobile phone can be manually adjusted the current time via the keypad as the time adjustment unit 12.

According to the preferred embodiment, the timer setter 21 comprises an input device 211 operatively linked with the time processor 22 to input the time interval. The user is able to input the amount of elapsed time as time interval. For example, the user is able to input 1 hour and 45 minutes as the time interval to the time processor 22 such that the time processor 22 will start to count 1 hour and 45 minutes at the time when the time interval is input. The user is also able to input 105 minutes, i.e. 1 hour and 45 minutes, as the time interval to the time processor 22. In other words, the time interval can be either counted by hour or minute.

The input device 211 is operatively linked to the time adjustment unit 12 of the time provider 10 such that when the input device 211 is activated, the user is able to input the time interval through the time adjustment unit 12. The input device 211 comprises an electronic input circuitry 2111 receiving a time interval signal in digit form in responsive to the time interval and sending the time interval signal to the time processor 22. Accordingly, when the time interval is input, the electronic input circuitry 2111 will convert the time interval into the time interval signal in digit form.

The time processor 22 comprises a time converter 221 converting the time interval into a hour setting signal and a minute setting signal, and a central management unit 222 configuring a designated time from the hour setting signal and the minute setting signal in responsive to the current time and sending out a time alert signal to the signal generator 23 when the designated time is reached.

Accordingly, when the time interval signal is input through the input device 211, the time interval signal is converted by the time converter 221 to form the hour setting signal and the minute setting signal in digit form. For example, when the user inputs 1 hour and 45 minutes as the time interval, the time converter 221 will convert the “1 hour” time interval as the hour setting signal and the “45 minutes” time interval as the minute setting signal. Likewise, when the user inputs 105 minutes as the time interval, the time converter 221 will automatically read the “105 minutes” and convert into the hour setting signal and the minute setting signal.

The central management unit 222 is arranged to configure the designated time when the time interval is input in responsive to the current time. For example, when the user inputs 1 hour and 45 minutes as the time interval at the current time of 13:48, the central management unit 222 will automatically configure the designated time as 15:33 by adding 1 hour and 45 minutes to the current time. Therefore, the central management unit 222 will send the time alert signal to the signal generator 23 at the designated time of 15:33. In other words, the user is able to simply input the time interval in which the central management unit 222 will automatically configure the designated time.

According to the preferred embodiment, the signal generator 23 comprises a sound generator generating a sound signal as the alert signal. Alternatively, the signal generator 23 can be an illuminator and/or a vibration generator generating a light signal and/or a vibration signal as the alert signal. It is worth to mention that the electronic watch or mobile phone generally incorporates with the built-in signal generator 23 such that the alert timer of the present invention is adapted to link to the signal generator 23. Therefore, the user is able to select one or more alert signals to be generated at the designated time. In order to stop the alert signal, the user is able to manually actuate the input device 211 to deactivate the signal generator 23 and to reset the time setter 21.

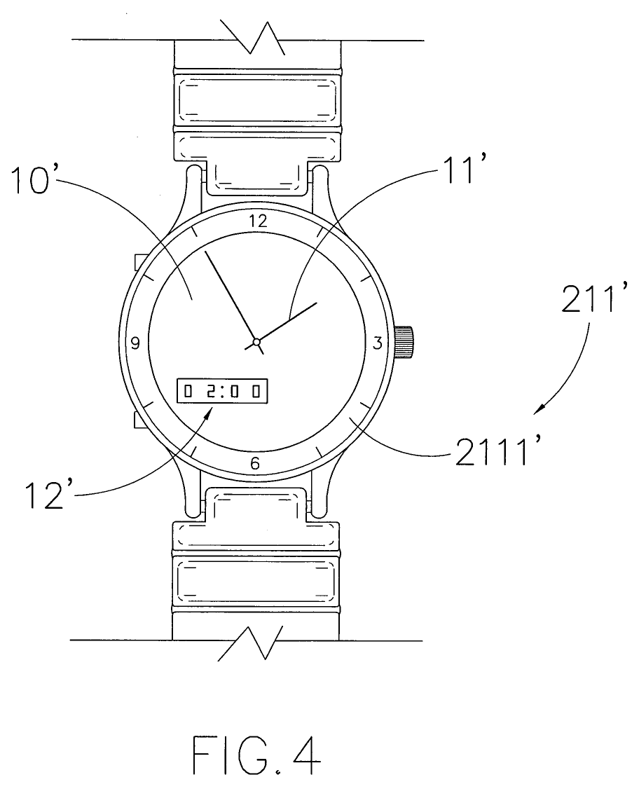

As shown in FIG. 4, the time provider 10′ is embodied as a mechanical watch wherein the time provider 10′ comprises a mechanical time mechanism 11′ generating a mechanical movement to provide the current time in analog form.

The timer setter 21′ comprises an input device 211′ operatively linked with the time processor 22 to input the time interval. Accordingly, the input device 211′ comprises a mechanical input device 2111′ being manually actuated to set the time interval. As shown in FIG. 3, the mechanical input device 2111′ comprises a turning wheel rotatably mounted on a top side of the mechanical watch, wherein the turning wheel is driven to revolve to input the time interval. For example, when the user turns the turning wheel with 1 and three quarters revolutions, the time interval is set as 1 hour and 45 minutes. In other words, one revolution of the turning wheel is set to be 60 minutes. Preferably, the time provider 10′ comprises a display screen 12′ to display the time interval input by the turning wheel. It is worth to mention that the turning wheel will automatically rotate back to its original position to count down the time interval. Once the turning wheel is back to the original position, the time alert signal is sent to the signal generator 23 at the designated time for generating the alert signal.

Accordingly, the user does not require determining the designated time as the conventional timepiece with a built-in alarm system. For example, when the user makes a one-hour speech to the audiences, he or she may simply set 50 minutes as the time interval at the time the speech begins. Once the alert signal is generated, the user is able to notice that he or she has 10 minutes to finish the speech. However, having the conventional timepiece, the user must set the designated time when the speech begins.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-20. (canceled)

21. A portable timepiece, comprising:
a time provider which is arranged to be conveniently carried to indicate a current time;
an alert timer which comprises a time setter setting a time interval at said current time as a starting time;
a time processor counting said time interval starting from said starting time; and
a signal generator automatically and timely generating an alert signal when said time processor finishes counting said time interval in responsive to said starting time, wherein said signal generator comprises a sound generator generating a sound signal as said alert signal, in such a manner that a user is able to arrange alert signal to be generated by setting said time interval by said alert timer without needing to manually calculate an exact time at which said time interval lapses from said current time in an outdoor environment.

22. The portable timepiece, as recited in claim 21, wherein said time setter comprises an input device operatively linked with said time processor to input said time interval.

23. The portable timepiece, as recited in claim 22, wherein said input device comprises an electronic input circuitry receiving a time interval signal in digit form as said time interval and sending said time interval signal to said time processor.

24. The portable timepiece, as recited in claim 21, wherein said time processor comprises a time converter converting said time interval into a hour setting signal and a minute setting signal, and a central management unit configuring a designated time from said hour setting signal and said minute setting signal in responsive to said current time and sending out a time alert signal to said signal generator when said designated time is reached.

25. The portable timepiece, as recited in claim 23, wherein said time processor comprises a time converter converting said time interval into a hour setting signal and a minute setting signal, and a central management unit configuring a designated time from said hour setting signal and said minute setting signal in responsive to said current time and sending out a time alert signal to said signal generator when said designated time is reached.

26. The portable timepiece, as recited in claim 21, wherein said time provider comprises an electronic time circuit generating an hour indicating signal and a minute indicating signal.

27. The portable timepiece, as recited in claim 25, wherein said time provider comprises an electronic time circuit generating a hour indicating signal and a minute indicating signal.

28. The portable timepiece, as recited in claim 27, wherein said signal generator further comprises an illuminator generating a light signal as said alert signal.

29. The portable timepiece, as recited in claim 28, wherein said signal generator further comprises a vibration generator generating a vibration signal as said alert signal.

30. The portable timepiece, as recited in claim 22, wherein said input device comprises a mechanical input device being manually actuated to set said time interval.

31. The portable timepiece, as recited in claim 30, wherein said time provider comprises a mechanical time mechanism generating a mechanical movement to provide said current time in analog form.

32. The portable timepiece, as recited in claim 31, wherein said signal generator further comprises an illuminator generating a light signal as said alert signal.

33. The portable timepiece, as recited in claim 32, wherein said signal generator further comprises a vibration generator generating a vibration signal as said alert signal.

34. A method of configuring an alert of a portable timepiece, comprising the steps of:
(a) providing a current time as a starting time;
(b) setting a time interval at said current time;
(c) counting down said time interval from said starting time; and
(d) automatically and timely generating an alert signal in a punctual time manner once said time interval is over, such that a user is able to arrange alert signal to be generated by setting said time interval by said alert timer without needing to manually calculate an exact time at which said time interval lapses from said current time in an outdoor environment.

35. The method as recited in claim 34, wherein, in the step (b), said time interval is input in digit form.

36. The method, as recited in claim 35, wherein the step (c) further comprises the steps of:
(c.1) converting said time interval into a hour setting signal and a minute setting signal;
(c.2) configuring a designated time from said hour setting signal and said minute setting signal in responsive to said current time; and
(c.3) sending out a time alert signal when said designated time is reached.

37. The method, as recited in claim 36, wherein the step (a) further comprises a step of generating a hour indicating signal and a minute indicating signal in responsive to said current time.

38. The method, as recited in claim 37, wherein said time interval is input in analog form and said current time is provided in analog form.
